(19) United States
(12) Patent Application Publication
(10) Pub. No.: US 2019/0288406 A1
(43) Pub. Date: Sep. 19, 2019

(54) ANTENNA FEED STRUCTURE AND BASE STATION ANTENNA

(71) Applicant: Rosenberger Technology (Kunshan) Co., Ltd, Kunshan (CN)

(72) Inventors: Zhongcao YANG, Kunshan (CN); Guoqun CHEN, Kunshan (CN); Ping HUANG, Kunshan (CN)

(21) Appl. No.: 16/433,172

(22) Filed: Jun. 6, 2019

Related U.S. Application Data
(63) Continuation of application No. PCT/CN2017/110657, filed on Nov. 13, 2017.

(30) Foreign Application Priority Data
Dec. 6, 2016 (CN) 201611101000.6

(51) Int. Cl. H01Q 25/00; H01Q 21/00; H01Q 1/24; H01Q 1/48

(52) U.S. Cl. CPC H01Q 25/001; H01Q 1/48; H01Q 1/246; H01Q 21/0025

(57) ABSTRACT

The invention discloses an antenna feed structure and a base station antenna. The base station antenna comprises a plane reflector and at least one antenna feed structure installed thereat. The antenna feed structure comprises a radiator, an antenna feed balun and an antenna feed board. The antenna feed balun comprises one end connected to the radiator, and another end passing through the antenna feed board to connect the ground. In operation, an excitation signal is transferred from the antenna feed board via the antenna feed balun to the radiator. The present invention can be utilized to enhance the performance of antenna radiation, and improve an antenna cross polarization ratio, facilitating an increase in an antenna gain, increasing the base station coverage and optimizing the electrical characteristics of an antenna.

### CROSS-REFERENCE TO RELATED PATENT APPLICATION

This application is a continuation application of international application No. PCT/CN2017/110657, filed on Nov. 13, 2017, which claims priority to Chinese patent application No. 201611101000.6, filed on Dec. 6, 2016, the disclosures of which are hereby incorporated by reference.

### FIELD

The present invention relates to the field of mobile communications, which is applied to a base station antenna feed system, in particular relate to an antenna feed structure and a base station antenna, which are used to improve the performance of antenna radiation and improve a cross polarization ratio of the antennas.

### BACKGROUND

As one of the most important components in a base station, a base station antenna is mainly responsible for converting electrical signals of a communication device and spatially radiated electromagnetic waves. The base station antennas can be classified into single-polarized base station antennas and dual-polarized base station antennas according to polarization modes. Compared with the single-polarized antenna, the dual-polarized antenna can shorten a spatial interval between antennas, and has the advantages of reducing the call loss and the interference, achieving high quality of service, etc.

The base station antennas are typically combined in an array form by radiating elements of the same structure. In the radiating elements of the base station antennas, considerable human and material resources have been invested in extensive and in-depth researches. Each radiating element generally comprises a radiating surface, a feed support plate and a feed base. The surface of the radiating surface is provided with a vibrator. The feed support plate is located between the radiating surface and the feed base, wherein one end of the feed support plate is connected with a vibrator on the radiating surface, and the other end thereof passes through the feed base and is connected to the ground.

In the prior art, the bottom surface (i.e., its surface connected to the ground) of the feed support plate of the above radiating element is generally connected to the ground directly, that is, its end surface connected to the ground is intermittent. In practical use and research experiments, we have found that the antenna with such an unintermittent grounding structure has a poor cross polarization ratio performance of the antenna radiation, and is difficult to debug, thereby affecting the characteristics of antenna gain, communication coverage quality and the like.

Therefore, it is necessary to improve the grounding structure of the above radiating element to improve the performances of antenna radiation and increase the cross polarization ratio of the antenna.

### SUMMARY

An objective of the present invention is to overcome the defects of the prior art, and provide an antenna feed structure and a base station antenna, which are used to improve the performance of antenna radiation and increase a cross polarization ratio of the antenna.

To fulfill said objective, the present invention provides the following technical solution: an antenna feed structure comprises a radiator, an antenna feed balun and an antenna feed board, wherein the antenna feed balun has one end connected to the radiator, and another end passing through the antenna feed board to connect the ground. In addition, at least a groove is provided at a surface of the end of the antenna feed balun connected to the ground.

Preferably, the position of the groove on the surface of the end of the antenna feed balun connected to the ground is adjustable. In the course of transmitting an excitation signal to a vibrator of the radiator, the current distribution of the antenna is changed by adjusting the position of the groove (i.e., a position of an indirectly grounded point of the antenna feed structure), to adjust the radiation performance, such that the performances of the antenna radiation, in particular a cross polarization ratio are greatly improved.

Preferably, the grooves on the surface of the end of the antenna feed balun connected to the ground are symmetrically distributed along a symmetric axis of the antenna feed balun.

Preferably, the antenna feed balun is further provided with at least one hole by digging.

Preferably, the antenna feed structure further comprises a plane reflector which is connected to the surface of the end of the antenna feed balun connected to the ground.

Preferably, the surface of the end of the antenna feed balun close to the radiator is provided with a bulge, the antenna feed balun is connected to the radiator by the bulge passes through the radiator.

Preferably, a first conductor and a second conductor are attached to the antenna feed balun; the first conductor is connected to the radiator by the bulge passes through the radiator; while the second conductor is connected with the bottom surface of the groove of the antenna feed balun.

Preferably, the antenna feed balun comprises a first antenna feed balun and a second antenna feed balun which are intersected; the grooves on the first antenna feed balun are symmetrically distributed along a symmetric axis of the first antenna feed balun; the grooves on the second antenna feed balun are symmetrically distributed along a symmetric axis of the second antenna feed balun.

Preferably, the first antenna feed balun and the second antenna feed balun are respectively provided with a clamping groove that is used for realizing the intersection of the first antenna feed balun and the second antenna feed balun.

Preferably, the groove is a strip-shaped groove.

Preferably, the groove is a rectangular groove; or the bottom surface of the groove is an arc-shaped surface, and the side surface of the groove is a vertical plane.

The present invention further provides a further technical solution: a base station antenna comprises a plane reflector and the at least one antenna feed structure, wherein the antenna feed structure is installed on the plane reflector.

Compared with the prior art, the present invention has the advantages that indirect grounding of the antenna feed balun is realized by forming the groove at the surface of the end of the antenna feed balun connected to the ground (i.e., a surface connected to the ground, connected to the antenna feed board, of the radiating element) or additionally digging a hole on the basis of forming the groove. In addition, the current distribution of the antenna is changed by adjusting the position of the intermittently grounded point to optimize the performance of a directional diagram, thereby greatly improving the radiation performance, in particular the cross polarization ratio, facilitating an increase in an antenna gain, improving the base station coverage and optimizing the electrical characteristics of the antenna.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1 is a stereoscopic schematic structural diagram of an antenna feed structure of the present invention;

FIG. 2 is a stereoscopic schematic structural diagram of the antenna feed structure (not provided with an antenna feed board) of the present invention;

FIG. 3 is a stereoscopic schematic structural diagram of an embodiment of a first antenna feed balun of the present invention;

FIG. 4 is a stereoscopic schematic structural diagram of a further embodiment of the first antenna feed balun of the present invention;

FIG. 5 is a stereoscopic schematic structural diagram of an embodiment of a second antenna feed balun of the present invention;

FIG. 6 is a stereoscopic schematic structural diagram of a further embodiment of the second antenna feed balun of the present invention;

FIG. 7 is a view showing an actual measurement effect of a directional diagram in which an existing antenna feed balun is directly connected to the ground; and

FIG. 8 is a view showing an actual measurement effect of a directional diagram in which an antenna feed balun of the present invention is indirectly connected to the ground.

### DETAILED DESCRIPTION

The technical solution of the embodiments of the present invention will be clearly and completely described below with reference to the accompanying drawings.

The accompanying drawings may show one or more structural features in different viewing angles. In each of the accompanying drawings, solid lines may be used to show visible outlines or edges of structures, and dashed lines may be used to show invisible or hidden outlines or edges of the structures.

According to an antenna feed structure and a base station antenna disclosed by the present invention, the performances of antenna radiation can be improved, and the cross polarization ratio of the antenna is improved, facilitating an increase in an antenna gain, improving the base station coverage and optimizing the electrical characteristics of the antenna.

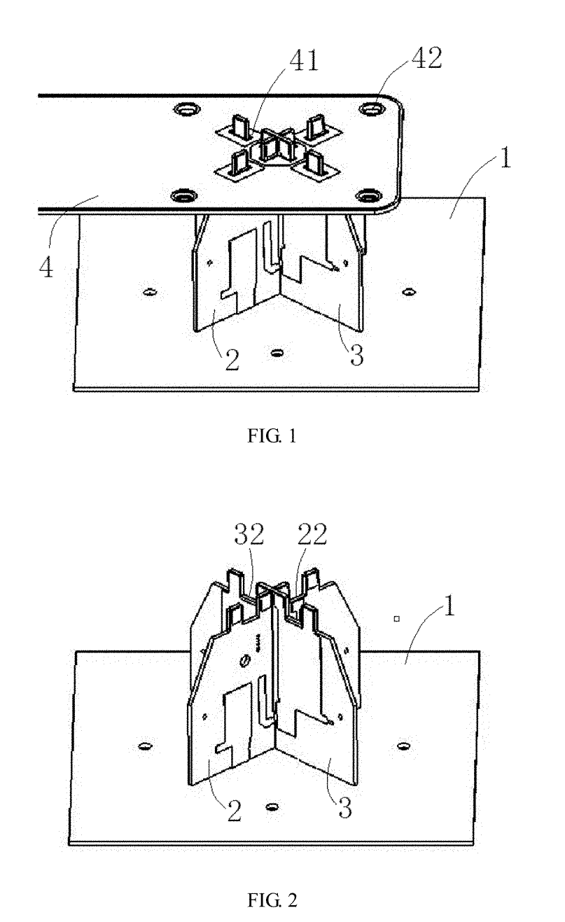

As shown in FIGS. 1 and 2, an antenna feed structure disclosed by an embodiment of the present invention comprises a radiator 1, an antenna feed balun, an antenna feed board 4 and a plane reflector (not shown in the figures). One end of the antenna feed balun passes through the radiator 1 and is connected with a vibrator (not shown in the figures) on the radiator 1, while the other end of the antenna feed balun passes through the antenna feed board 4, and is connected with the plane reflector to be grounded. Meanwhile, the radiator 1 and the antenna feed board 4 are both perpendicular to the antenna feed balun, i.e., the radiator 1 and the antenna feed board 4 are parallel. Excitation signals are transferred from the antenna feed board 4 via the antenna feed balun to the radiator 1 and then radiated to the outside.

The antenna feed balun comprises a first antenna feed balun 2 and a second antenna feed balun 3, which are orthogonal to each other, for feeding electricity to respective corresponding vibrators (not shown in the figures) on the radiator 1 to achieve two vertical polarizations, that is, achieving dual polarizations.

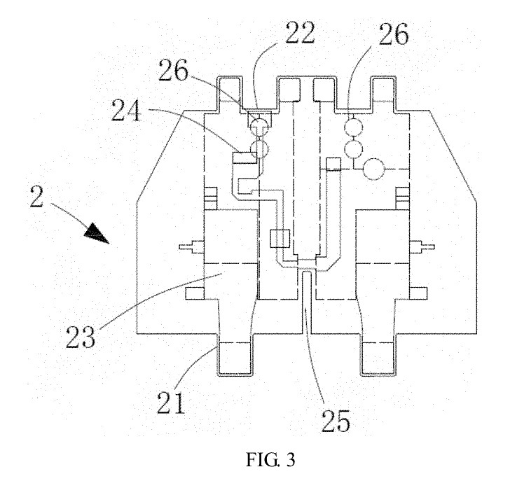

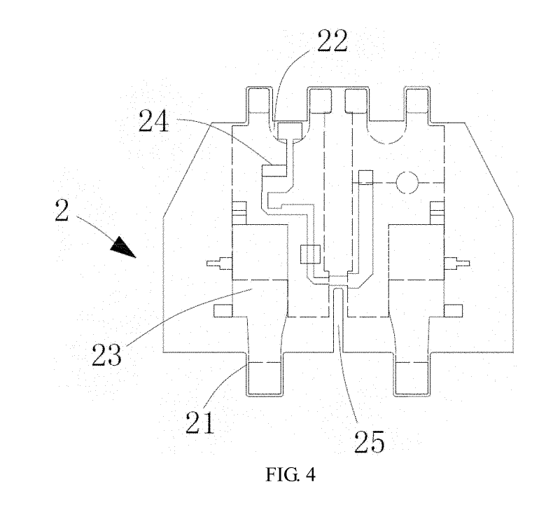

Specifically, as shown in FIGS. 3 and 4, a bulge 21 is set on the surface of the end of the first antenna feed balun 2 close to the radiator 1. The bulge 21 of the first antenna feed balun 2 passes through the radiator 1. The end surface of the first antenna feed balun 2 close to the antenna feed board 4 is provided with a groove 22. The groove 22 is arranged such that the surface of the end of the first antenna feed balun 2 connected to the ground (i.e., the surface of the end that passes through the antenna feed board) is not continuous, but is discontinuous, i.e., achieves intermittent grounding.

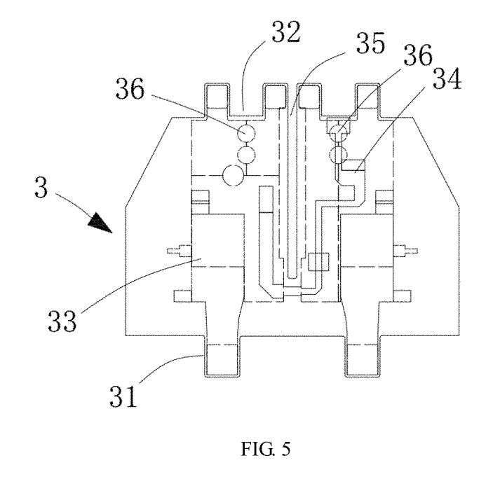

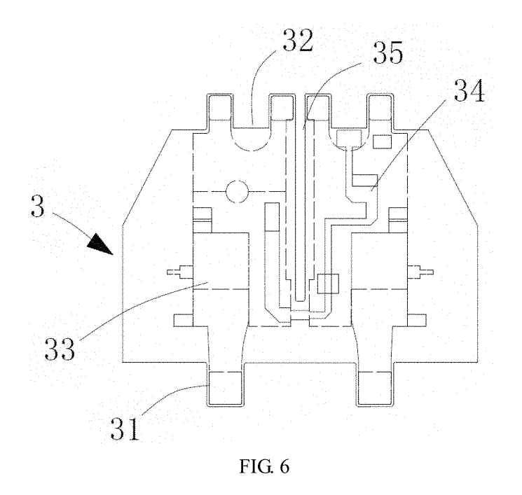

Similarly, as shown in FIGS. 5 and 6, two opposite end surfaces of the second antenna feed balun 3 are defined a corresponding bulge 31 and a groove 32 respectively, wherein the arrangement position, shape and the like of the bulge 31 and the groove 32 are the same as those on the first antenna feed balun 2, which specifically refers to the description of the first antenna feed balun 2 described above.

Further, besides the grooves 22, 32 respectively set on the first antenna feed balun 2 and the second antenna feed balun 3, at least one hole 26, 36 may be further defined respectively, wherein the holes 26, 36 may be formed in the back surface of the respective antenna feed balun to interfere the grounding current distribution of the antenna feed baluns 2, 3, as shown in FIG. 3.

Preferably, in this embodiment, the grooves 22 on the first antenna feed balun 2 are symmetrically distributed along a symmetric axis of the first antenna feed balun 2. The grooves 32 of the second antenna feed balun 3 are symmetrically distributed along a symmetric axis of the second antenna feed balun 3 as well.

Of course, the number, size, shape and other parameters of the grooves 22, 32 formed on the two feeding baluns 2, 3 are not limited in the present invention and can be adjusted according to actual needs. In this embodiment, there are two grooves 22, 23, which are symmetric along the symmetric axis of the respective antenna feed balun and are strip-shaped. As shown in FIGS. 3-6, each groove may be a rectangular groove, the bottom surface of which may be an arc-shaped surface and the side surface of which may be a vertical plane.

Further, the positions of the grooves 22, 32 formed on the surface of the end of the respective antenna feed baluns 2, 3 may be adjusted as required. The positions of the grounded points on the antenna feed baluns 2, 3 may be changed to change the current distribution of the antenna and adjust the performances of the antenna radiation.

As shown in FIGS. 3-6, first conductors 23, 33 and second conductors 23, 24 are attached to the first and second antenna feed baluns 2, 3 respectively, wherein the first conductors 23, 33 are connected to the vibrator of the radiator 1 by the bulges of the first and second antenna feed baluns 2, 3 pass through the radiator 1. The second conductors 24, 34 are connected with the bottom surface of the groove in the corresponding antenna feed balun.

In addition, the first antenna feed balun 2 and the second antenna feed balun 3 are respectively provided with a clamping groove 25, 35 for realizing the intersection of the first antenna feed balun 2 and the second antenna feed balun 3. In this embodiment, the clamping grooves 25, 35 are formed along the symmetric axis of the first antenna feed balun 2 and the second antenna feed balun 3 to realize symmetric intersection of the two antenna feed baluns.

The antenna feed board 4 is used for feeding electricity to the antenna feed baluns 2, 3. Specifically, as shown in FIG. 1, the antenna feed board 4 is defined feed holes 41 corresponding to the surfaces of the antenna feed baluns 2, 3 connected to the ground. The surfaces connected to the ground are connected to the ground by these feed holes 41 the antenna feed board 4, Feed signals feed electricity to the antenna feed baluns 2, 3 through these feed holes 41.

The antenna feed board 4 is further defined at least a fixing hole 42. The antenna feed board is fixed to the plane reflector through corresponding fixing elements passing through these fixing holes 42. In this embodiment, there are four circular fixing holes, connecting lines of which constitute a rectangular area. The indirectly grounded surface where the feeding baluns 2 and 3 intersect are located in the rectangular area. Of course, the shape and the number of the fixing holes 42 are not specifically limited in the present invention.

The plane reflector is connected to the antenna feed board 4 and is arranged close to the antenna feed board 4, i.e., the whole antenna feed structure is fixed to the plane reflector. The plane reflector may be provided with one or more antenna feed structures, thereby forming a base station antenna structure.

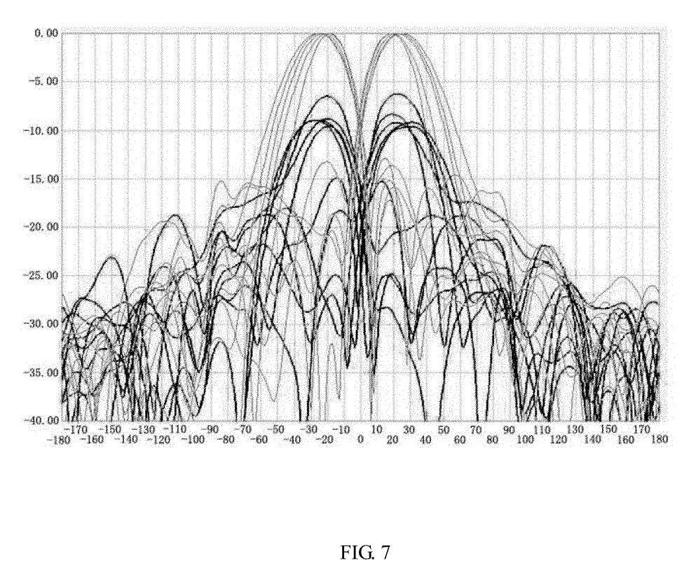

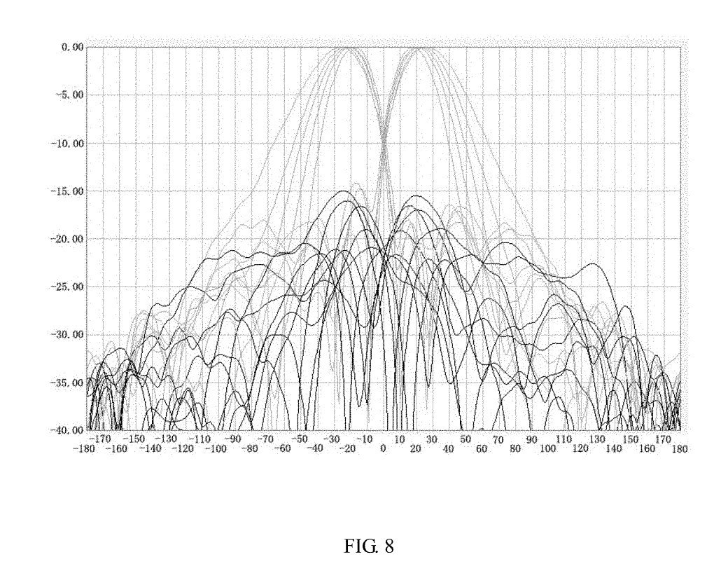

Therefore, the current distribution on the antenna may be changed by forming the grooves on the surface of the end of the antenna feed baluns connected to the ground, thereby optimizing the performances of a directional diagram. FIG. 7 and FIG. 8 show an actual measurement effect diagram in which the existing antenna feed balun is connected to the ground directly and an actual measurement effect diagram of a directional diagram of indirect grounding of the present invention. In these two diagrams, the dark curve represents cross polarization, the light curve represents main polarization, and the five curves corresponding to the two colors represent the test frequency of 1.7/1.9/2.0/2.2/2.4 GHz, respectively. In the two graphs, the abscissa represents a horizontal azimuth angle of 0-360°, and the ordinate represents a level value of the radiation pattern of the main polarization and the cross polarization. It should be noted that the farther the cross polarization curve in the graph is from the apex of the main-polarization curve, the better the cross polarization ratio is. Therefore, as can be seen from FIG. 8, the cross polarization ratio of the present invention is significantly higher than that of the existing base station antenna.

The technical content and technical features of the present invention have been disclosed as above, however, those skilled in the art can still make various substitutions and modifications without departing from the spirit and scope of the present invention. Therefore, the protection scope of the present invention should be limited to the content disclosed by the embodiments, but should include various substitutions and modifications without departing the present invention, and are covered by the claims of this patent application.

What is claimed is:

1. An antenna feed structure, comprising a radiator, an antenna feed balun and an antenna feed board, wherein the antenna feed balun has one end connected to the radiator, and another end passing through the antenna feed board to connect the ground; and at least a groove is provided at a surface of the end of the antenna feed balun connected to the ground.

2. The antenna feed structure according to claim 1, wherein the position of the groove on the surface of the end of the antenna feed balun connected to the ground is adjustable.

3. The antenna feed structure according to claim 1, wherein the groove on the surface of the end of the antenna feed balun connected to the ground are symmetrically distributed along a symmetric axis of the antenna feed balun.

4. The antenna feed structure according to claim 1, wherein the antenna feed balun is further defined at least one hole.

5. The antenna feed structure according to claim 1, wherein the surface of the end of the antenna feed balun close to the radiator is defined a bulge, the antenna feed balun is connected to the radiator by the bulge passes through the radiator.

6. The antenna feed structure according to claim 5, wherein a first conductor and a second conductor are attached to the antenna feed balun; the first conductor is connected to the radiator by the bulge passes through the radiator; while the second conductor is connected with the bottom surface of the groove of the antenna feed balun.

7. The antenna feed structure according to claim 1, wherein the antenna feed balun comprises a first antenna feed balun and a second antenna feed balun which are intersected; the grooves on the first antenna feed balun are symmetrically distributed along a symmetric axis of the first antenna feed balun; the grooves on the second antenna feed balun are symmetrically distributed along a symmetric axis of the second antenna feed balun.

8. The antenna feed structure according to claim 1, wherein the groove is a strip-shaped groove.

9. The antenna feed structure according to claim 8, wherein the groove is a rectangular groove; or the bottom surface of the groove is an arc-shaped surface, and the side surface of the groove is a vertical plane.

10. A base station antenna, comprising a plane reflector and at least one antenna feed structure according to claim 1, wherein the antenna feed structure is installed on the plane reflector.
